(19) United States
(12) Patent Application Publication
(10) Pub. No.: US 2005/0180037 A1
(43) Pub. Date: Aug. 18, 2005

(54) Electronic filter wheel

(75) Inventor: Hugh J. Masterson, Broomfield, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Boulder Nonlinear Systems, Inc., Lafayette, CO (US)

(21) Appl. No.: 10/782,341

(22) Filed: Feb. 18, 2004

(51) Int. Cl. G01N 21/25; G02B 5/22; G02B 7/00

(52) U.S. Cl. 359/892; 359/891

(57) ABSTRACT

A device is provided for selectively filtering an incident beam of light. A first interference-filter array is arranged to separate the incident beam into a plurality of spectrally complementary beams. An array of configurable optical shutters is disposed along paths of the separated beams to selectively block transmission of respective separated beams. A second interference-filter array is arranged to combine the separated beams whose transmission has not been blocked in accordance with states of the configurable optical shutters to produce a filtered output beam of light.

### BACKGROUND OF THE INVENTION

This application relates generally to filtering light. More specifically, this application relates to devices and methods for selectively filtering an incident beam of light to produce an output beam in accordance with specific device states.

There are numerous applications in which it is desirable to change the wavelength characteristics of light easily. In some such applications, the ability to change wavelength characteristics is desirable so that light with different wavelength properties may be used as separate sources of illumination; in other applications, it is desirable to examine different wavelength portions of received light separately. Applications for which such capabilities are useful are diverse, ranging from aerospace and astronomical applications to delicate medical applications, among numerous others. In astronomical applications, for instance, different parts of a received spectrum may contain different types of useful information so that it is helpful to examine those different spectral portions separately. In various medical techniques, illumination of tissue at different frequencies may provide valuable diagnostic information, and may in some instances be a useful aid to certain surgical techniques.

Selection of different wavelength characteristics may be accomplished by use of a filter wheel, a simple prior-art example of which is shown schematically in FIG. 1. Such a filter wheel 100 includes a base 108 having a plurality of holes suitable for holding filters 104. When the holes are covered by filters 104 that allow the transmission of different wavelength bands of light, it is possible to select the different wavelength bands by movement of the filter wheel 100. Typically, the filter wheel 100 is mounted so that selection of different wavelength bands may be accomplished by rotation of the base 108 so that a desired one of the filters 104 is positioned to intercept a beam of light. The beam of light may be a source of illumination so that on object is illuminated only with a desired portion of the spectrum, or may be a received beam so that only a desired portion of the received beam is used. In some cases, one of the holes in the base may be blocked by an opaque covering so that a position of the filter wheel prevents any transmission of light.

### BRIEF SUMMARY OF THE INVENTION

Embodiments of the invention provide an electronic version of a filter wheel that has is both more convenient and more versatile than a prior-art filter wheel of the type described in connection with FIG. 1. These embodiments include both devices and methods for selectively filtering an incident beam of light.

In a first set of embodiments, a device for selectively filtering an incident beam of light comprises first and second interference-filter arrays and an array of configurable optical shutters. The first interference-filter array is arranged to separate the incident beam into a plurality of spectrally complementary beams. The array of configurable optical shutters is disposed along paths of the separated beams to selectively block transmission of respective separated beams. The second interference-filter array is arranged to combine the separated beams whose transmission has not been blocked in accordance with states of the configurable optical shutters to produce a filtered output beam of light.

The first interference-filter array may comprise a first band-edge interference filter disposed to encounter the incident beam and a mirror disposed to encounter one of the plurality of spectrally complementary beams. In some embodiments, the first interference-filter array additionally comprises a plurality of second band-edge interference filters disposed along an optical path between the first band-edge interference filter and the mirror. In one such embodiment, the interference filters and the mirror are inclined at substantially 45° relative to the optical path between the first band-edge interference filter and the mirror. The first band-edge interference filter may comprise a high-pass band-edge interference filter and the second band-edge interference filters may comprise low-pass band-edge interference filters. Alternatively, the first band-edge interference filter may comprise a low-pass band-edge interference filter and the second band-edge interference filters may comprise high-pass band-edge interference filters. Examples of suitable interference filters that may be comprised by the first interference-filter array include a dichroic beamsplitter, a Raman edge filter, and a Rugate notch filter. In one alternative embodiment, the first interference-filter array comprises a first mirror disposed to reflect the incident beam, a band-edge interference filter disposed to encounter the incident beam reflected from the first mirror, and a second mirror disposed to encounter one of the plurality of spectrally complementary beams.

The second interference-filter array may comprise a first band-edge interference filter from which the output beam emanates and a mirror. In some embodiments, the second interference-filter array additionally comprises a plurality of second band-edge interference filters disposed along an optical path between the first band-edge interference filter and the mirror. In one such embodiment, the interference filters and the mirror are inclined at substantially 45° relative to the optical path between the first band-edge interference filter and the mirror. The first band-edge interference filter may comprise a high-pass band-edge interference filter and the second band-edge interference filters may comprise low-pass band-edge interference filters. Alternatively, the first band-edge interference filter may comprise a low-pass band-edge interference filter and the second band-edge interference filters may comprise high-pass band-edge interference filters. Examples of suitable interference filters that may be comprised by the second interference-filter array include a dichroic beamsplitter, a Raman edge filter, and a Rugate notch filter.

In different embodiments, the optical shutters may comprise mechanical shutters or may comprise liquid-crystal shutters. In some instances, the light may be polarized by the device. For example, in one embodiment, an input polarizer may be disposed to be encountered by the incident beam prior to encountering the first interference-filter array. An output polarizer oriented at 90° relative to the input polarizer may be disposed to be encountered by the output beam. In another embodiment, a plurality of input polarizers may be disposed to encounter each of the separated beams prior to encountering the array of configurable optical shutters. A plurality of output polarizers, each of which is oriented at 90° relative to a corresponding input polarizer, may be disposed to encounter each of the separated beams that are transmitted through respective optical shutters. In one embodiment, the incident beam may be split into beams having complementary polarizations, with each such beam being filtered and recombined as described.

In a second set of embodiments, a device is also provided for selectively filtering an incident beam of light. A first beamsplitter is disposed to separate the incident beam into spectrally complementary first and second beams. An optical train provides optical paths for the first and second beams from the first beamsplitter. Configurable optical shutters are disposed as an array along the optical paths to selectively prevent transmission of light along each of the optical paths. A first optical combiner is disposed relative to the optical paths to combine light transmitted along the optical paths according to states of the optical shutter to produce a filtered beam of light.

In some such embodiments, the optical train comprises a second beamsplitter disposed to separate the second beam into a plurality of spectrally complementary second beams. The optical train may also comprise a plurality of mirrors disposed to define the optical path for one of the plurality of second beams. In some cases, the optical train further comprises a second optical combiner disposed to combine light transmitted along the optical paths for the plurality of second beams according to states of the optical shutters. In some instances, a plurality of input polarizers may be disposed to encounter each of the first and second beams prior to encountering the array of configurable optical shutters. A plurality of corresponding output polarizers may also be disposed to encounter each of the first and second beams after encountering the array of configurable optical shutters, with each input polarizer and corresponding output polarizer having a relative orientation of 90°. In another embodiment, an input polarizer may be disposed to be encountered by the incident beam prior to encountering the first beamsplitter and an output polarizer disposed to be encountered by the output beam, the input and output polarizers again having a relative orientation of 90°.

In some embodiments, each of the beamsplitters and optical combiners may be oriented at substantially 45° relative to one of the optical paths. The first beamsplitter and first optical combiner may comprise high-pass band-edge interference filters and the second beamsplitter and second optical combiner may comprise low-pass band-edge interference filters. Alternatively, the first beamsplitter and first optical combiner may comprise low-pass band-edge interference filters and the second beamsplitter and second optical combiner may comprise high-pass band-edge interference filters. Such interference filters may comprise dichroic beamsplitters, Raman edge filters, Rugate notch filters, and the like. The optical shutters may comprise mechanical shutters or liquid-crystal shutters in different embodiments.

In a third set of embodiments, a method is provided for selectively filtering an incident beam of light. The incident beam is separated into a plurality of spectrally complementary beams. Transmission of some of the separated beams is selectively blocked. The separated beams that are not blocked are combined to produce a filtered output beam of light.

In some such embodiments, blocking transmission of some of the separated beams may be performed by routing the separated beams along distinct optical paths to respective optical shutters and selecting states of the optical shutters. The incident beam may be separated into a first beam that includes wavelengths above a first cutoff wavelength and a second beam that includes wavelengths below the first cutoff wavelength. One of the first and second beams may correspond to a remainder beam, with the incident beam being separated by successively separating the remainder beam according to a further cutoff wavelength into a third beam and a further remainder beam. Similarly, the separated beams that are not blocked may be combined by successively adding one separated beam at a time to a combination beam to produce the filtered output beam. In one embodiment, the incident beam is polarized and the filtered output beam is polarized. In another embodiment, each of the separated beams is polarized prior to selectively blocking transmission of some of the separated beams; each of the separated beams that are not blocked is polarized after selectively blocking transmission of some of the separated beams.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic illustration of a prior-art filter wheel;

FIGS. 2A and 2B provide schematic illustrations of different states of a device for selectively filtering light in one embodiment of the invention;

FIG. 3 provides a schematic illustration of an embodiment of the invention suitable for a larger number of spectral bands;

FIG. 4 provides a schematic illustration of an embodiment of the invention that uses polarizers;

FIG. 5 provides a schematic illustration of an embodiment of the invention that uses multiple polarizers; and

FIG. 6 provides a flow diagram summarizing methods for filtering light in certain embodiments.

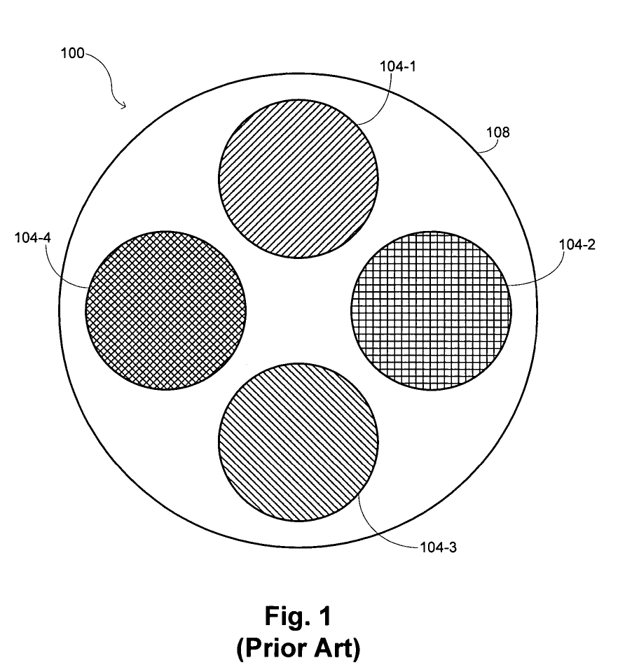

### DETAILED DESCRIPTION OF THE INVENTION

Embodiments of the invention use an arrangement of optical components that allows selection of particular filtering characteristics to be made electronically. In some embodiments, the entire operation of the filtering device is advantageously nonmechanical so that no moving parts are needed to switch among different filtering characteristics. Furthermore, some embodiments permit superposition of filtering states so that bandwidths of selected spectral portions may be adjusted, or so that bimodal or multimodal selections of spectral portions may be made, with substantially equal or substantially different bandwidths of each of the component modes.

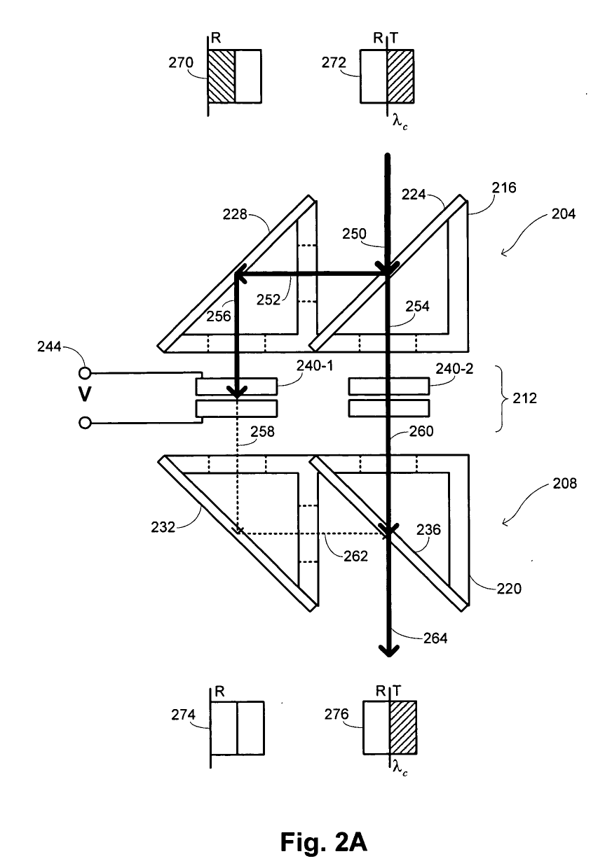

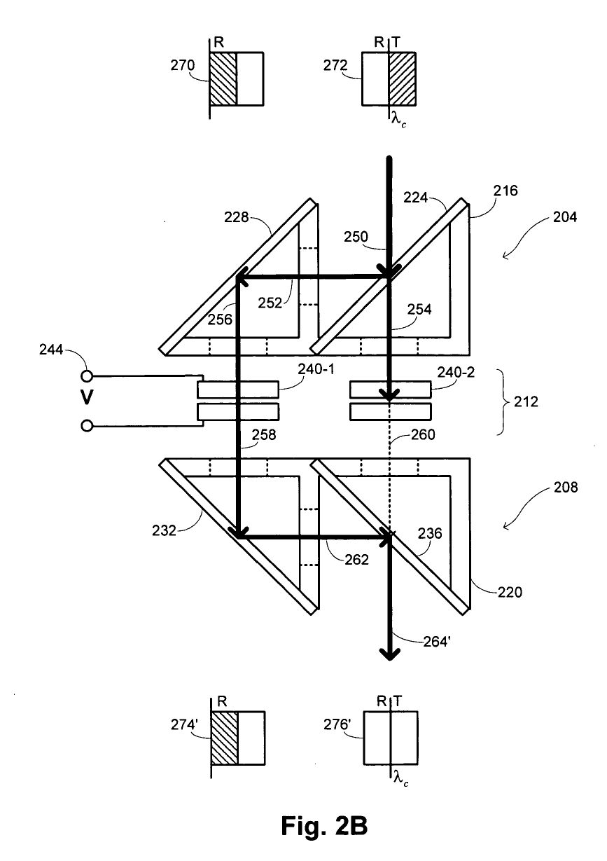

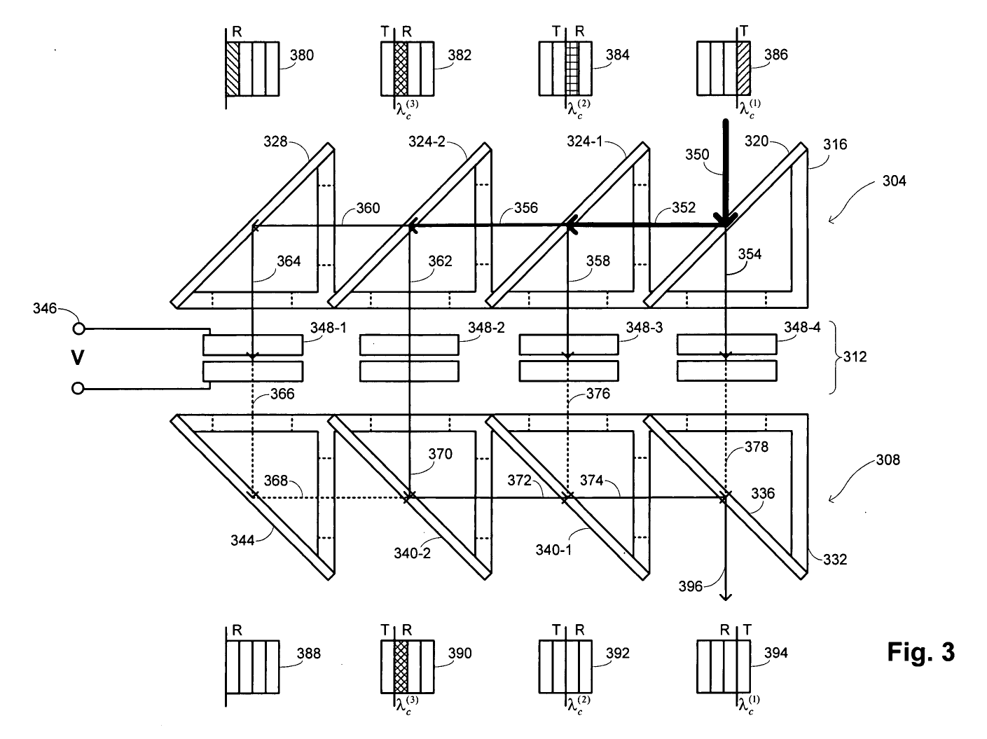

An overview of the principles used by a device made in accordance with an embodiment of the invention is provided in FIGS. 2A and 2B, with each of the two drawings showing side views of the same device but in different states. For simplicity of illustration, the device shown in FIGS. 2A and 2B is appropriate for selection among two spectral bands; the devices described below in connection with FIGS. 3-5 illustrate additional features that may be used in embodiments appropriate for selection among a greater number of spectral bands. In the discussion that follows, embodiments of the invention are illustrated using interference filters, which are intended to refer generally to any optical filter that reflects a portion of the electromagnetic spectrum and transmits a portion of the electromagnetic spectrum. In some embodiments, such interference filters may comprise multiple thin dielectric layers having different refractive indices and perhaps also metallic layers. The wavelength selectivity of the interference filter arises from interference effects that take place between incident and reflected waves at the thin-film boundaries. The term is intended to encompass Raman edge filters, Rugate filters, notch filters, and other nonabsorbing filters.

The device includes a first interference-filter array 204 configured to act as a dividing array that separates an incident beam 250 into a plurality of spectrally complementary beams 256 and 254. The incident beam 250 is initially separated with a high-pass band-edge interference filter 224 disposed to encounter the incident beam 250. The high-pass band-edge interference filter 224 transmits light above a cutoff wavelength λ_{c} and reflects light below the cutoff wavelength λ_{c}. This is indicated schematically by box 272, which separates a spectral distribution with a vertical line at wavelength λ_{c}, the portion above λ_{c} being identified as transmitted by symbol “T” and the portion below λ_{c} being identified as reflected by symbol “R”; the transmitted portion of the spectral distribution is also identified by hatching.

The spectrally complementary beams are directed to an array 212 of configurable optical shutters 240, states of which may be used to selectively block transmission of respective separated beams. In the embodiment shown in FIGS. 2A and 2B, the high-pass band-edge filter 224 is inclined at an angle substantially equal to 45° relative to the incident beam 250. This allows the first of the spectrally complementary beams 254 to be provided directly to one of the configurable optical shutters 240-2 as the portion transmitted by the high-pass band-edge interference filter 224. The other beam 256 may result from a further reflection off a mirror 228 of the beam 252 reflected from the high-pass band-edge interference filter 224, the arrangement directing this beam 256 to another of the configurable optical shutters 240-1. The spectral characteristics of beam 256 are indicated with box 270, which uses a vertical line to indicate that all wavelengths incident on the mirror 228 are reflected (“R”); the portion of the spectrum that is actually received and reflected is identified by hatching. The high-pass band-edge interference filter 224 and mirror 228 may be supported by a structure 216 that includes holes or other transparent portions, as indicated in shadow line, to allow propagation of light between the optical elements.

The spectral bands desired in the output beam of light are defined by states of the configurable optical shutters 240, each of which may allow or block transmission of received light by attenuating the light. In one embodiment, the configurable optical shutters 240 may comprise mechanical shutters, although in other embodiments they may comprise nonmechanical shutters such as liquid-crystal shutters. For example, the configurable optical shutters 240 may comprise twisted nematic devices, ferroelectric polarization rotators, and the like. The states of such devices may be defined by voltage levels applied to each of the devices, as indicated in the drawings with voltage source 244. In instances where polymer-dispersed liquid-crystal (“PDLC”) cells are used, the light provided to the beams may be unpolarized, although in other instances it may be preferable for the beams impinging on the shutters 240 to be polarized. Further discussion is provided below describing considerations that may be made in embodiments that use polarized light.

The beams selected for transmission according to states of the shutters 240 are directed to a second interference-filter array 208 configured to act as a recombining array. The second interference-filter array 208 is structured to perform the inverse operation of the first interference-filter array 204, and may in some embodiments be structurally equivalent to the first interference-filter array 204. For instance, in the embodiment shown, a mirror 232 and a high-pass band-edge interference filter 236 are positioned at substantially 45° relative to the selected beams and are supported by structure 220.

The structure of the device shown in FIGS. 2A and 2B may alternatively be viewed as providing optical paths from high-pass band-edge filter 224 acting as a beamsplitter to high-pass band-edge filter 236 acting as an optical combiner. The optical paths are provided by an optical train that includes mirrors 228 and 232, with the shutters 240 disposed along the optical paths to selectively prevent transmission of light.

FIG. 2A illustrates a state of the device that selects the band having wavelengths greater than λ_{c}. In this state, shutter 240-1 is configured to block transmission of beam 256, so that no beam follows paths 258 and 262 from the shutter 240-1 to the mirror 232 to high-pass band-edge interference filter 236. The absence of such a beam is indicated schematically by box 274, which is similar to box 270 but showing that no spectral bands are included along that path. Shutter 240-2 is configured to allow transmission of beam 254 along path 260 directly to the high-pass band-edge interference filter 236, as indicated schematically by box 276, which shows that the spectral characteristics of the transmitted beam are the same as those shown for beam 254 in box 272. The high-pass band-edge interference filter 236 acts to combine light transmitted along the two optical paths. The geometrical arrangement allows this to be accomplished by transmitting those wavelengths above λ_{c} and reflecting those with wavelengths below λ_{c}. Accordingly, output beam 264 includes that spectral portion of incident beam 250 with wavelengths above λ_{c}, the remaining wavelengths having been filtered by the device.

FIG. 2B shows how changing the states of the shutters 240 may change the spectral characteristics of the output beam. In this instance, shutter 240-1 is configured to allow transmission of beam 256 and shutter 240-2 is configured to block transmission of beam 254. This is further indicated by boxes 274′ and 276′, which show the spectral characteristics of the beams after encountering the shutters 240-beam 256, having wavelengths below λ_{c}, is transmitted along path 258 where it is reflected by the mirror 232 along path 262 to the high-pass band-edge interference filter 236; nothing is transmitted along path 260. In this instance, combining the light transmitted along the separate optical paths results in an output beam 264′ that includes only that portion of incident beam 250 with wavelengths below λ_{c}. This is again accomplished with the illustrated geometrical arrangement and the property of the high-pass band-edge interference filter 236 to transmit wavelengths above λ_{c} but to reflect wavelengths below λ_{c}. For these states of the shutters 240, the device thus provides a different filtering of the incident beam.

In other states, the device may be configured to allow transmission of the entire incident beam 250 by selecting states of the shutters 240 to allow transmission of each of the spectrally complementary beams. Alternatively, the device could be configured to block transmission entirely of the incident beam by selecting states of the shutters 240 to block each of the spectrally complementary beams.

The principles illustrated with FIGS. 2A and 2B may be extended to permit selection among more than two spectral bands of the incident beam. In one embodiment, illustrated with a schematic side view in FIG. 3, this is accomplished by extending the capability of the first interference-filter array to separate the incident beam into a greater number of spectrally complementary beams by adding low-pass band-edge filters. Similarly, the capability of the second interference-filter array to recombine spectrally complementary beams may also be extended by adding low-pass band-edge filters. For each of these arrays, the low-pass band-edge filters are disposed along an optical path between the high-pass band-edge filter and the mirror. Each of the low-pass band-edge filters acts oppositely to the high-pass band-edge filter by transmitting that portion of a beam below a cutoff wavelength and reflecting the portion above the cutoff wavelength. As shown in FIG. 3, the optical geometry is simplified when each of the interference filters and mirrors is inclined at substantially 45° relative to the direction of the incident beam.

FIG. 3 provides a specific illustration of the operation of such a device in an embodiment that allows selection among four spectrally complementary bands. In this embodiment, the dividing array comprises a structure 316 to support a high-pass band-edge filter 320, two low-pass band-edge filters 324, and a mirror 328. The structure 316 includes holes or otherwise transparent sections identified in shadow line to allow propagation of light within the device as described below. The incident beam 350 encounters the high-pass edge-band interference filter 320, which reflects that portion of the beam 350 below a first cutoff wavelength λ_{c}⁽¹⁾ as beam 352 and transmits that portion of the beam above λ_{c}⁽¹⁾ as beam 354. The operation of the high-pass band-edge interference filter 320 is indicated schematically with box 386, with hatching used to show transmission (“T”) of that portion of the beam above λ_{c}⁽¹⁾, thereby also illustrating the spectral structure of beam 354.

Beam 352 is directed to a first of the low-pass edge-band interference filters 324-1, which reflects that portion of the beam above a second cutoff wavelength λ_{c}⁽²⁾ as beam 358 and transmits that portion below λ_{c}⁽²⁾ as beam 356. This is indicated schematically by box 384, with labels “T” and “R” denoting respectively which portions are transmitted and reflected. The hatch portion of the box between λ_{c}⁽¹⁾ and λ_{c}⁽²⁾ thus designates the spectral boundaries of beam 358. Similarly, beam 356 is directed to a second of the low-pass edge-band interference filters 324-2, which reflects that portion of the beam above a third cutoff wavelength λ_{c}⁽³⁾ as beam 362 and transmits that portion below λ_{c}⁽³⁾ as beam 360. This is also indicated schematically by box 382, with similar “T” and “R” labels and with the hatched portion between λ_{c}⁽²⁾ and λ_{c}⁽³⁾ designating the spectral boundaries of beam 362. This basic pattern may be repeated, selectively extracting a different spectral region from the beam, until a final beam is produced. In the embodiment with four defined spectral regions, the final beam is beam 360, which is reflected from mirror 328 to produce beam 364. The behavior of the mirror 328 as purely reflective and the characteristics of beam 364 are indicated with box 380, showing that beam 364 includes only spectral components having a wavelength less than λ_{c}⁽³⁾.

The result of providing the incident beam 350 to the first interference-filter array 304 is thus the separation of the incident beam into a plurality of spectrally complementary beams 354, 358, 362, and 364, having the spectral characteristics indicated by boxes 386, 384, 382, and 380. These beams are directed to an array 312 of configurable optical shutters 348, which in this embodiment includes four shutters 348, i.e. equal in number to the number of spectrally complementary beams. As described in connection with FIG. 2, each of the shutters may be a mechanical or nonmechanical shutter, but may allow or block transmission of received beams. In cases of certain nonmechanical shutters such as liquid-crystal shutters, the states may be defined by voltage levels applied with a voltage source 346. The spectral composition of the final output beam depends on the states of the shutters, including only components that correspond to those beams allowed transmission by shutter states.

The recombination of the selected beams is performed by the second interference-filter array 308 in a similar fashion described in connection with FIG. 2. The second interference-filter array 308 may be structurally equivalent to the first interference-filter array 304, as is the case with the embodiment shown in FIG. 3. Like the first interference-filter array 304, the second interference-filter array 308 includes a structure 332 to support a high-pass band-edge filter 336, two low-pass band edge filters 340, and a mirror 340, together with holes or otherwise transparent sections to allow unimpeded light propagation between optical elements. The optical arrangement causes light allowed transmission from each of the shutters 348 to be combined successively one beam at a time to produce the output beam 396. Thus, light from shutter 348-1 follows path 366 to mirror 344 from which it is reflected along path 368. Low-pass band-edge filter 340-2 combines light received along path 368 with light received directly from shutter 348-2 along path 370, propagating the combination along path 372. Similarly, low-pass band-edge filter 340-1 combines light received along path 372 with light received directly from shutter 348-3 along path 376, propagating the combination along path 374. Finally, high-pass band-edge filter 336 combines light received along path 374 with light received directly from shutter 348-4 to produce the output beam 396. It is evident that, similar to the dividing array, the recombining array may include additional low-pass band-edge filters to accommodate a greater number of spectral channels in other embodiments.

The manner in which the shutter states determine the spectral composition of the output beam 396 may be illustrated with the specific state shown in FIG. 3. In this specific state, only shutter 348-2 is in a state that allows transmission of light, with all of the other shutters in states that completely attenuate light. The shutter states act to limit light in the output beam 396 to be between λ_{c}⁽²⁾ and λ_{c}⁽³⁾, and defining how light is combined from the various optical paths thus amounts to illustrating the path taken by beam 362 to the output beam 396. Boxes 388, 390, 392, and 394 illustrate the spectral distribution of the respective light emanating from each of the shutters 348, and includes “T” and “R” designations to indicate the transmission and reflection properties of the respective optical elements. Thus, as boxes 388, 392, and 394 show, no light is received by any element from shutters 348-1, 348-2, or 348-3. The light received from shutter 348-2 is reflected by low-pass band-edge filter 340-2 because it has only wavelengths greater than λ_{c}⁽³⁾, is transmitted through low-pass band-edge filter 340-1 because it has only wavelengths less than λ_{c}⁽²⁾, and is reflected by high-pass band-edge filter 336 because it has only wavelengths less than λ_{c}⁽¹⁾.

Similar to comments made above in connection with FIGS. 2A and 2B, the structure of the device shown in FIG. 3 may alternatively be viewed as providing optical paths from high-pass band-edge filter 320 acting as a beamsplitter to high-pass band-edge filter 336 acting as an optical combiner. The optical paths are provided by an optical train that includes low-pass band-edge filters 324 and 340 as well as mirrors 328 and 344. The low-pass band-edge filters 324 in the dividing array 304 may themselves be viewed as elements of the optical train that act as beamsplitters to split a portion of the previously split incident beam. Similarly, the low-pass band-edge filters 340 in the recombining array 308 may themselves be viewed as elements of the optical train that act as optical combiners to combine light emanating from the shutters 348, which are disposed along the optical paths to selectively prevent transmission of light.

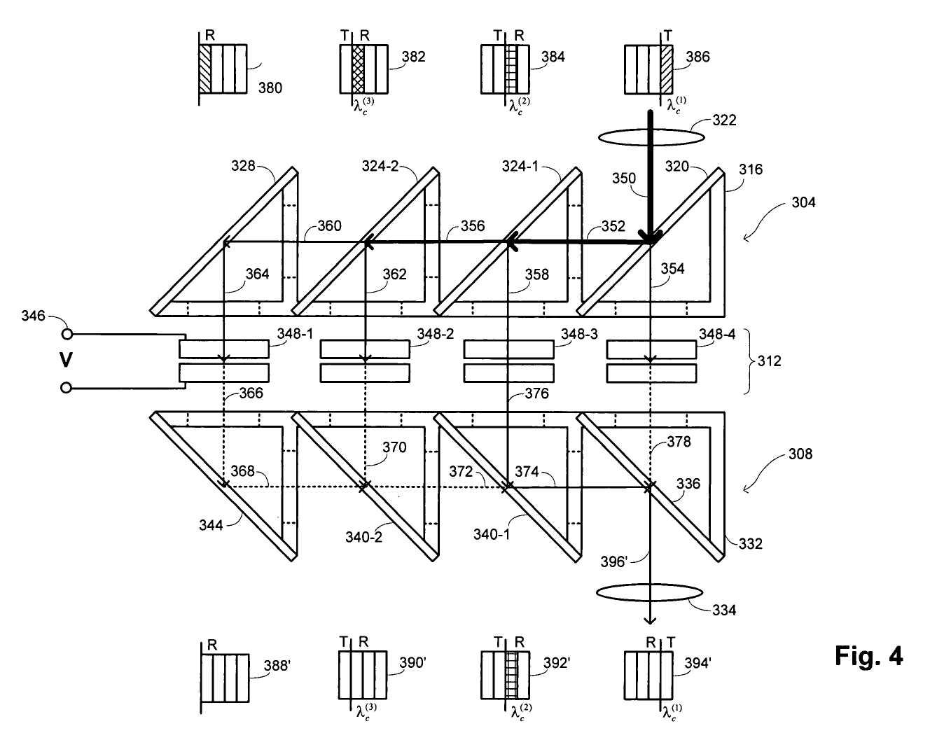

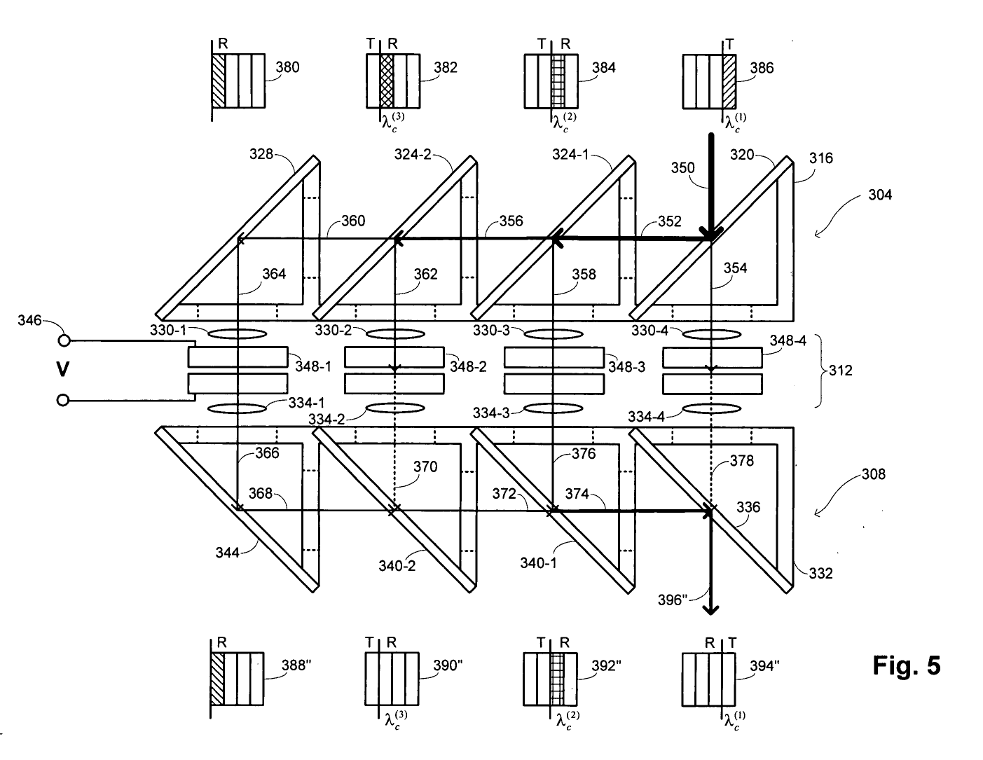

FIGS. 4 and 5 provide illustrations of different embodiments that polarize light, and also illustrate different states for the shutters 348 to demonstrate how different spectral characteristics of the output beam may be achieved. The operation of certain types of shutters exploits changes in polarization to switch between transmissive and blocking states. This is true, for example, for a wide class of liquid-crystal shutters that excludes PDLC devices. Polarizing the incident and output beams permits such shutters to be used by implementing voltage-controlled polarization rotation to switch between the transmissive and blocking states. Thus, FIG. 4 provides an example of an embodiment in which the incident beam 350 is polarized by an input polarizer 322 and in which the output beam 397 is polarized by an output polarizer 334. The input and output polarizers have a relative orientation of 90°. The operation of this embodiment is otherwise similar to that described in connection with FIG. 3.

The use of polarizers may have other advantages in some embodiments. For example, it will be appreciated that ability to separate the incident beam 320 into an arbitrarily large number of spectrally complementary beams is limited by the sharpness of the band edges provided by the interference filters, even if arbitrarily large numbers of filters are used. It is well known that interference filters used at angles other than normal incidence exhibit a smearing of the band-end profile. This smearing results from angular separation of the S and P polarized components, where the S polarization is perpendicular to the plane of incidence. Polarizing the light acts to mitigate the smearing of the band-edge profile, in some cases effectively restoring the edge sharpness, although the angular position of the band edge may still be shifted.

The choice of whether to use a system that includes polarization components may reflect a determination of whether throughput or channel definition is of greater concern in a particular application. For example, if very well-defined channels are a primary consideration, it may be preferable to polarize the light. Conversely, if throughput is a greater concern so that more broadly separated channels are acceptable with the possibility of some overlap, a configuration that uses mechanical or PDLC shutters, for instance, may be used without polarization. This may be the case in color-imaging applications, for example, among others. Furthermore, the overlap of channels in embodiments that do not polarize the light may alternatively be addressed by including additional notch or edge filters to eliminate the regions of overlap. Such embodiments may be especially suitable for applications in which high throughput is desired with well isolated spectral channels. These additional features might comprise interference filters, but could alternatively comprise absorptive color filters, holographic notch filters, or some other type of filter.

FIG. 4 also illustrates the effect of changing the shutter states in the shutter array 312. In this instance, only shutter 348-3 is in a state that allows transmission of light, i.e. of beam 359, so that the shutter-array state differs from that of FIG. 3 by changes in the states of shutters 348-2 and 348-3. This shutter-array state acts to limit light in the output beam 396′ to be between λ_{c}⁽¹⁾ and λ_{c}⁽²⁾, Thus, the combination of light along the defined optical paths proceeds by reflecting light received along path 376 from low-pass band-edge filter 340-1 because it has only wavelengths greater than λ_{c}⁽²⁾, and reflecting light received along path 374 from high-pass band-edge filter 336 because it has only wavelengths less than λ_{c}⁽¹⁾. The boxes at the bottom of the figure differ from those of FIG. 3 to reflect the change in shutter states. In particular, box 390′ indicates that no spectral components emanate from shutter 348-2 while box 392′ indicates that spectral components between λ_{c}⁽¹⁾ and λ_{c}⁽²⁾ have been allowed through shutter 348-3; boxes 388′ and 394′ show that there continues to be no transmission through shutters 348-1 or 348-4.

While FIG. 4 provides an example of an embodiment that uses polarization by providing a single input polarizer and a single output polarizer, it may be preferable in other embodiments to use a greater number of polarizers. FIG. 5 provides an illustration of an alternative embodiment in which input polarizers 330 and output polarizers 334 are associated with each shutter 348. In some instances, these polarizers 330 and 334 might respectively be mounted in the holes of the support structures 316 and 332 used to ensure free propagation of light between optical components. There are a number of applications in which this alternative use of multiple polarizers may be preferred. For example, different polarizing materials may be better suited for operating in different spectral regions. In cases where the device is to be used to sample a relatively large spectral region, it may be desirable to use an arrangement like that shown in FIG. 5, with some polarizers 330 and 334 made of different material more suitable for their respective spectral regions. Furthermore, while some polarizing materials may be effective over larger spectral regions, it may be more economical to use multiple polarizers of different materials that have narrow spectral breadth but which are significantly less costly.

While FIGS. 3 and 4 provided examples of shutter states that filter a single spectral band defined by the cutoff wavelengths λ_{c}, FIG. 5 provides an example where a plurality of such spectral bands are included in the output beam 396″. In this instance, shutters 348-1 and 348-3 are in states that allow transmission of beams 364 and 358, while transmission of beams 362 and 354 is blocked by the states of shutters 348-2 and 348-4. This state provides a bimodal filtering of the incident beam 350 that allows transmission of wavelengths less than λ_{c}⁽³⁾ and of wavelengths between λ_{c}⁽¹⁾ and λ_{c}⁽²⁾. The different separated beams are combined by a process that includes reflecting the beam received along path 366 and having wavelengths less than λ_{c}⁽³⁾ off mirror 344 along path 368. This beam is transmitted through low-pass band-edge filter 340-2 because it only includes wavelengths below λ_{c}⁽²⁾. Nothing is received along path 370 to be reflected from low-pass band-edge filter 340-2 so that the light propagated along path 372 includes the same spectral content as beam 364. Low-pass band-edge filter 340-1 combines this spectral content with light having wavelengths between λ_{c}^{(1) and λ}_{c}⁽²⁾ received along path 376—the light received along path 372 is transmitted because it includes only wavelengths less than λ_{c}⁽²⁾, and the light received along path 376 is reflected because it includes only wavelengths greater than λ_{c}⁽²⁾. Light having this bimodal distribution of wavelengths is reflected from high-pass band-edge filter 336 because all of the wavelengths remain less than λ_{c}⁽¹⁾. Since nothing is received along path 378 for transmission through high-pass band-edge filter 336, the output beam 396″ also has this wavelength distribution. The boxes at the bottom of the figure illustrate the spectral content of the beams transmitted from the shutters, and identify the transmission and reflection properties of the respective optical components of the second interference-filter array 308 as previously described. Boxes 390″ and 394″ show that no light is transmitted by shutters 348-1 and 348-2, while boxes 388″ and 392″ use hatching to show each of the two spectral regions transmitted through respective shutters 348-1 and 348-3.

While the state illustrated in FIG. 5 provides an example of a shutter state that causes the device to filter the incident beam in a bimodal fashion, it will be appreciated that this is merely one example of a broad range of filtering characteristics that may be implemented with embodiments of the invention. This is particularly true when a greater number of optical elements are included to accommodate a larger number of spectral channels. In such embodiments, shutter states may be used that implement arbitrarily multimodal filtering characteristics by setting discrete separated shutters for transmission. Furthermore, the width of individual spectral channels may be adjusted by having greater or lesser numbers of adjacent shutters surrounding a central wavelength in states that allow transmission. For instance, the device could be configured to filter an incident beam narrowly about ko by allowing transmission of only the separated beam that includes λ₀. Broader filtering could be accomplished by further allowing transmission of separated beams on either side of the beam that includes λ₀. This technique for controlling the wavelength bandwidth of the filtered output beam may also be applied in a bimodal or multimodal fashion for highly specialize applications. For example, a bimodal filtering could be provided in which each of the distinct transmitted channels has a different wavelength width. Furthermore, while the illustrations in FIGS. 2-5 show individually controlled spectral channels as having substantially equal widths in wavelength, this is not a requirement; the interference filters may alternatively be selected so that the individual channels have different widths.

There are a number of other alternatives to the specific embodiments shown in FIGS. 2-5 that are also within the scope of the invention. Several are noted herein merely by way of example. For instance, while the embodiments have been described specifically in which the incident beam encounters a high-pass band-edge filter and the output beam emanates from a high-pass band-edge filter, these components may be substituted with low-pass band-edge filters in other embodiments. In such embodiments, the other interference filters in both the dividing and recombining arrays may be substituted with high-pass band-edge filters. The operation of the devices with such substitutions is the same as described above, except that progressively higher-wavelength channels are selected along the device rather than progressively lower-wavelength channels as in the main description. In still other embodiments, the first element 320 of the dividing array 304 and/or the last element 336 of the recombining array 308 may be substituted with mirrors inclined as indicated in FIGS. 3-5. In such embodiments, the operation of the devices is still as described above, with low-pass band-edge filters being used in place of the high-pass band-edge filters specifically described because the first channel is again reflected rather than transmitted.

In further embodiments, polarization loss may be reduced by directing different polarizations of the incident beam through separate filtering assemblies. For instance, referring again to FIG. 3, the first element 320 of the dividing array 304 may comprise an achromatic beamsplitter, such as a wire-grid polarizer. One polarization, say the S polarization, is reflected from the beamsplitter and propagated through the assemblies as shown to selectively filter desired channels. The complementary polarization, say the P polarization, is transmitted through the beamsplitter and then reflected by a mirror to a similar assembly having a dividing array and a combining array. This reflection may be to a propagation direction orthogonal to the filter plane of the first filtering assembly, i.e. in or out of the page of FIG. 3. This complementary polarization is filtered in the same manner as described above with this second assembly and is reflected back to the combining element 336 of the recombining array 308 of the first assembly. Because the second assembly is a perpendicular arm, the polarization is changed to a complementary polarization, i.e. the P polarized light becomes S polarized. Combining the light from the two paths in this way avoids the polarization loss while still providing high channel definition.

In some embodiments, the low-pass and/or high-pass band-edge interference filters may comprise dichroic beam splitters configured for separation into orthogonal beam directions, may comprise standard interference filters with the band edge calculated for operation as a 45° beamsplitter, may comprise Raman edge filters, may comprise Rugate filters, and the like. An arrangement of Rugate notch filters may comprise, for example, a sequence of notches defined by a notch on each filter that progresses through the spectral region of interest. With such an arrangement, the reflected component from each filter is a narrow passband that defines a particular channel so that selection and recombination of particular channels may be performed as described in connection with FIGS. 2-5. Also, in an alternative embodiment, the optical paths used within the device may be folded by including additional optical elements such as mirrors or prisms, although the principles of operation used are as described above. The use of folded optical paths allows the device to be constructed more compactly, a feature that may be advantageous in certain applications where the size of the device is a consideration. Furthermore, all of the embodiments described specifically above are examples of a single line-of-sight device. Such a configuration may be advantageous for a number of applications, but is not required; in other embodiments, the device may be configured without a single line of sight using the same principles described.

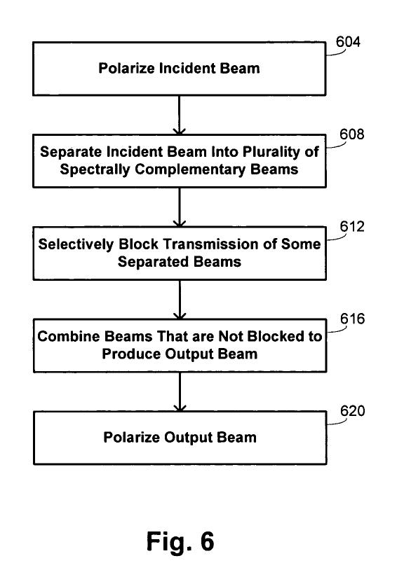

These principles are conveniently summarized with the flow diagram of FIG. 6, which illustrates methods for selectively filtering an incident beam of light. While this flow diagram sets forth a number of functions that are performed in a certain order, neither the specific listing of functions nor the order is intended to be limiting. In other embodiments, some of the functions might not be performed, some additional functions might be performed, or the functions may be performed in a different order than that indicated. In those embodiments that make use of polarization, such as to mitigate smearing of band-edge profiles in performing certain functions, the incident beam may be polarized at block 604. The incident beam is separated into a plurality of spectrally complementary beams and block 608, and transmission of some of the separated beams is selectively blocked at block 612. The beams that are not blocked are combined at block 616 to produce the filtered output beam, which may be polarized as indicated at block 620 in those embodiments that use polarization.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A device for selectively filtering an incident beam of light, the device comprising:
a first interference-filter array arranged to separate the incident beam into a plurality of spectrally complementary beams;
an array of configurable optical shutters disposed along paths of the separated beams to selectively block transmission of respective separated beams; and
a second interference-filter array arranged to combine the separated beams whose transmission has not been blocked in accordance with states of the configurable optical shutters to produce a filtered output beam of light.

2. The device recited in claim 1 wherein the first interference-filter array comprises:
a first band-edge interference filter disposed to encounter the incident beam; and
a mirror disposed to encounter one of the plurality of spectrally complementary beams.

3. The device recited in claim 2 wherein the first interference-filter array further comprises a plurality of second band-edge interference filters disposed along an optical path between the first band-edge interference filter and the mirror.

4. The device recited in claim 3 wherein the interference filters and the mirror are inclined at substantially 45° relative to the optical path between the first band-edge interference filter and the mirror.

5. The device recited in claim 3 wherein:
the first band-edge interference filter comprises a high-pass band-edge interference filter; and
the second band-edge interference filters comprise low-pass band-edge interference filters.

6. The device recited in claim 3 wherein:
the first band-edge interference filter comprises a low-pass band-edge interference filter; and
the second band-edge interference filters comprise high-pass band-edge interference filters.

7. The device recited in claim 1 wherein the first interference-filter array comprises:
a first mirror disposed to reflect the incident beam;
a band-edge interference filter disposed to encounter the incident beam reflected from the first mirror; and
a second mirror disposed to encounter one of the plurality of spectrally complementary beams.

8. The device recited in claim 1 wherein the second interference-filter array comprises:
a first band-edge interference filter from which the output beam emanates; and
a mirror.

9. The device recited in claim 8 wherein the second interference-filter array further comprises a plurality of second band-edge interference filters disposed along an optical path between the first band-edge interference filter and the mirror.

10. The device recited in claim 9 wherein the interference filters and the mirror are inclined at substantially 45° relative to the optical path between the first band-edge interference filter and the mirror.

11. The device recited in claim 9 wherein:
the first band-edge interference filter comprises a high-pass band-edge interference filter; and
the second band-edge interference filters comprise low-pass band-edge interference filters.

12. The device recited in claim 9 wherein:
the first band-edge interference filter comprises a low-pass band-edge interference filter; and
the second band-edge interference filters comprise high-pass band-edge interference filters.

13. The device recited in claim 1 wherein the second interference-filter array comprises:
a first mirror from which the output beam emanates;
a second mirror disposed to encounter one of the plurality of spectrally complementary beams; and
a band-edge interference filter disposed between the first and second mirrors and disposed to transmit the output beam to the first mirror.

14. The device recited in claim 1 wherein the optical shutters comprise mechanical shutters.

15. The device recited in claim 1 wherein the optical shutters comprise liquid-crystal shutters.

16. The device recited in claim 1 wherein the first interference-filter array comprises an interference filter selected from the group consisting of a dichroic beam splitter, a Raman edge filter, and a Rugate notch filter.

17. The device recited in claim 1 wherein the second interference-filter array comprises an interference filter selected from the group consisting of a dichroic beam splitter, a Raman edge filter, and a Rugate notch filter.

18. The device recited in claim 1 further comprising:
an input polarizer disposed to be encountered by the incident beam prior to encountering the first interference-filter array; and
an output polarizer disposed to be encountered by the output beam,
wherein the input and output polarizers have a relative orientation of 90°.

19. The device recited in claim 1 wherein the first interference-filter array is further arranged to separate the incident beam into a plurality of beams having complementary polarizations, the plurality of spectrally complementary beams having a first polarization, the device further comprising:
a third interference-filter array arranged to separate a beam having a second polarization into a second plurality of spectrally complementary beams;
a second array of configurable optical shutters disposed along paths of the second plurality of spectrally complementary beams to selectively block transmission of respective ones of the second plurality of spectrally complementary beams; and
a fourth interference-filter array arranged to combine the second plurality of spectrally complementary beams whose transmission has not been blocked in accordance with states of the second array of configurable optical shutters,
wherein the second interference-filter array is further arranged to combine the combination of the second plurality of spectrally complementary beams with the filtered output beam of light.

20. The device recited in claim 1 further comprising:
a plurality of input polarizers disposed to encounter each of the separated beams prior to encountering the array of configurable optical shutters;
a plurality of corresponding output polarizers disposed to encounter each of the separated beams that are transmitted through respective optical shutters,
wherein each input polarizer and corresponding output polarizer have a relative orientation of 90°.

21. A device for selectively filtering an incident beam of light, the device comprising:
a first beamsplitter disposed to separate the incident beam into spectrally complementary first and second beams;
an optical train providing optical paths for the first and second beams from the first beamsplitter;
an array of configurable optical shutters disposed along the optical paths to selectively prevent transmission of light along each of the optical paths; and
a first optical combiner disposed relative to the optical paths to combine light transmitted along the optical paths according to states of the optical shutters to produce a filtered output beam of light.

22. The device recited in claim 21 wherein the optical train comprises a second beamsplitter disposed to separate the second beam into a plurality of spectrally complementary second beams.

23. The device recited in claim 22 wherein the optical train further comprises a plurality of mirrors disposed to define the optical path for one of the plurality of second beams.

24. The device recited in claim 22 wherein the optical train further comprises a second optical combiner disposed to combine light transmitted along the optical paths for the plurality of second beams according to states of the optical shutters.

25. The device recited in claim 24 further comprising:
a plurality of input polarizers disposed to encounter each of the first and second beams prior to encountering the array of configurable optical shutters; and
a plurality of corresponding output polarizers disposed to encounter each of the first and second beams after encountering the array of configurable optical shutters,
wherein each input polarizer and corresponding output polarizer have a relative orientation of 90°.

26. The device recited in claim 24 wherein each of the beamsplitters and optical combiners is oriented at substantially 45° relative to one of the optical paths.

27. The device recited in claim 21 wherein:
the first beamsplitter and first optical combiner comprise high-pass band-edge interference filters; and
the second beamsplitter and second optical combiner comprise low-pass band-edge interference filters.

28. The device recited in claim 21 wherein:
the first beamsplitter and first optical combiner comprise low-pass band-edge interference filters; and
the second beamsplitter and second optical combiner comprise high-pass band-edge interference filters.

29. The device recited in claim 27 wherein the interference filters comprise dichroic beamsplitters.

30. The device recited in claim 27 wherein the interference filters comprise Raman edge filters.

31. The device recited in claim 27 wherein the interference filters comprise Rugate notch filters.

32. The device recited in claim 21 wherein the optical shutters comprise mechanical shutters.

33. The device recited in claim 21 wherein the optical shutters comprise liquid-crystal shutters.

34. The device recited in claim 21 further comprising:
an input polarizer disposed to be encountered by the incident beam prior to encountering the first beamsplitter; and
an output polarizer disposed to be encountered by the output beam,
wherein the input and output polarizers are have a relative orientation of 90°.

35. A method for selectively filtering an incident beam of light, the method comprising:
separating the incident beam into a plurality of spectrally complementary beams;
selectively blocking transmission of some of the separated beams; and
combining the separated beams that are not blocked to produce a filtered output beam of light.

36. The method recited in claim 35 wherein selectively blocking transmission of some of the separated beams comprises routing the separated beams along distinct optical paths to respective optical shutters and selecting states of the optical shutters.

37. The method recited in claim 35 wherein separating the incident beam comprises separating the incident beam into a first beam that includes wavelengths above a first cutoff wavelength and a second beam that includes wavelengths below the first cutoff wavelength.

38. The method recited in claim 37 wherein one of the first and second beams corresponds to a remainder beam and separating the incident beam further comprises successively separating the remainder beam according to a further cutoff wavelength into a third beam and a further remainder beam.

39. The method recited in claim 35 wherein combining the separated beams that are not blocked comprises successively adding one separated beam at a time to a combination beam to produce the filtered output beam.

40. The method recited in claim 35 further comprising:
polarizing the incident beam; and
polarizing the filtered output beam.

41. The method recited in claim 35 further comprising:
polarizing each of the separated beams prior to selectively blocking transmission of some of the separated beams; and
polarizing each of the separated beams that are not blocked after selectively blocking transmission of some of the separated beams.

42. The method recited in claim 35 further comprising:
separating the incident beam into a plurality of beams having complementary polarizations, the plurality of spectrally complementary beams having a first polarization;
separating a beam having a second polarization into a second plurality of spectrally complementary beams;
selectively blocking transmission of some of the second plurality of spectrally complementary beams;
combining the second plurality of spectrally complementary beams that are not blocked; and
combining the combination of the second plurality of spectrally complementary beams with the filtered output beam.

43. A device for selectively filtering an incident beam of light, the device comprising:
means for separating the incident beam into a plurality spectrally complementary beams;
means for selectively blocking transmission of some of the separated beams; and
means for combining the separated beams that are not blocked to produce a filtered output beam of light.

44. The device recited in claim 43 wherein the means for selectively blocking transmission of some of the separated beams comprise means for routing the separated beams along distinct optical paths to respective optical shutters and selecting states of the optical shutters.

45. The device recited in claim 43 wherein the means for separating the incident beam comprise means for separating the incident beam into a first beam that includes wavelengths above a first cutoff wavelength and a second beam that includes wavelengths below the first cutoff wavelength.

46. The device recited in claim 45 wherein one of the first and second beams corresponds to a remainder beam and the means for separating the incident beam further comprise means for successively separating the remainder beam according to a further cutoff wavelength into a third beam and a further remainder beam.

47. The device recited in claim 43 wherein the means for combining the separated beams that are not blocked comprise means for successively adding one separated beam at a time to a combination beam to produce the filtered output beam.

48. The device recited in claim 43 further comprising:
means for polarizing the incident beam; and
means for polarizing the filtered output beam.

49. The device recited in claim 43 further comprising:
means for polarizing each of the separated beams prior to selectively blocking transmission of some of the separated beams; and
means for polarizing each of the separated beams that are not blocked after selectively blocking transmission of some of the separated beams.
